(19) United States
(12) Patent Application Publication
(10) Pub. No.: US 2009/0291288 A1
(43) Pub. Date: Nov. 26, 2009

(54) MOLDED PARTS FROM HOT MELT ADHESIVES

(75) Inventors: Siegfried Kopannia, Krefeld (DE); Carsten Friese, Duesseldorf (DE); Rainer Schoenfeld, Duesseldorf (DE)

Correspondence Address: HENKEL CORPORATION, One Henkel Way, ROCKY HILL, CT, 06067, US

(73) Assignee: Henkel AG & Co. KGaA, Duesseldorf (DE)

(21) Appl. No.: 12/474,559

(22) Filed: May 29, 2009

Related U.S. Application Data
(63) Continuation of application No. PCT/EP2007/061007, filed on Oct. 16, 2007.

(30) Foreign Application Priority Data
Nov. 29, 2006 (DE) 102006056660.2
Apr. 30, 2007 (DE) 102007020652.8

(51) Int. Cl. B32B 27/32; C08G 69/26; C09J 131/02; B32B 27/34; B32B 27/36; B32B 37/06

(52) U.S. Cl. 428/220; 528/341; 525/186; 156/275.7

(57) ABSTRACT

The invention relates to a molded part for bonding to metal or plastic substrates for use as a fastening element. Said molded part comprises a hot melt adhesive, said hot melt adhesive being based on polyamide, polyolefins, polyesters, polyacrylates or polystyrene. The molded part according to the invention is characterized in that the hot melt adhesive has a softening point between 100° and 250° C., a tensile stress at yield of between 1 and 35 MPa and the molded part consists entirely of the hot melt adhesive. The invention also relates to a method for bonding molded parts from hot melt adhesives to substrates by way of inductive heating.

### CROSS-REFERENCE TO RELATED APPLICATIONS

This application is a continuation under 35 U.S.C. Sections 365(c) and 120 of International Application No. PCT/EP2007/061007, filed Oct. 16, 2007 and published on Jun. 5, 2008 as WO 2008/0064950, which claims priority from German Patent Application Nos. 102006056660.2 filed Nov. 29, 2006 and 102007020652.8 filed Apr. 30, 2007, which are incorporated herein by reference in their entirety.

### FIELD OF THE INVENTION

The invention relates to molded articles for bonding to metal or plastic substrates for use inter alia for fastening conduits or pipes.

### BACKGROUND OF THE INVENTION

Molded articles made of various materials are known. For example, molded articles based on polyamides are also known. Polyamides based on C₄-C₁₈ dicarboxylic acids and diamines are described in EP 1 533 331 as molding compounds for the manufacture of molded articles in low pressure injection molding processes. Other molded articles, such as cables, cable connection assemblies, contact sleeves etc., can be cast into such liquid hot melt adhesive molded articles and thus provide a solid mechanical joint.

In addition, EP 0 586 450 is known. This describes hot melt adhesives, made of inter alia polyamides, which have a specific melting range. Cables or connection assemblies can then be encapsulated with such molten hot melt adhesives. There results a bonded and sealed encasement of the connection assembly.

From EP 0 504 957, molded aluminum articles are known which can be used as a fastening means for other objects. These aluminum fasteners are provided underneath with a hot melt adhesive that comprises finely powdered iron particles.

A process is described in DE 102 16 948 for bonding two construction parts, wherein both construction parts are joined together with a jointing agent, wherein the jointing agent possesses an electrically conductive component as well as a second thermoplastic plastic component. The conductive compound can be heated by an induction coil and subsequently forms a bond to both construction parts. Fastening elements are likewise described in DE 100 32 817 and are coated on one side with an electrically conductive adhesive that consists of a thermoplastic bonding agent together with electrically conductive particles, the latter helping to melt the thermoplastic bonding agent.

The known prior art assumes that metallic or thermosetting molded articles are encased in a hot melt adhesive and sealed. On the other hand, metallic or plastic molded articles are coated on one side and the molded article is adhesively bonded on this side with a second substrate, for example a flat metallic substrate. The use of thermosetting molded articles or metallic molded articles, which are intended to be adhesively bonded, regularly leads to the problem that an adhesive must be selected that adheres well to both substrates. This must also remain unchanged under exposure to higher temperatures or to mechanical loading, for example from vibration.

Another requirement of the adhesive bond is that the assembly should occur over a short period and then produce a high adhesion. Hot melt adhesives that establish a bond on crystallization are suitable for this. Reactive adhesives frequently require a long reaction time before developing a final adhesive bond.

### SUMMARY OF THE INVENTION

Starting from the prior art, the object was to manufacture a molded article as a fastening element, which enables a rapid adhesive bonding to the substrates, which does not have multiple adhesion surfaces of the adhesive to substrates, and which exhibits a satisfactory elasticity, in order to ensure strength even at higher temperatures or under increased mechanical loading.

The object is achieved according to the invention as described herein. A molded article is accordingly provided that consists of hot melt adhesives that have a high softening temperature. The hot melt adhesive should be highly elastic and have a tensile stress at yield of 1 to 35 MPa.

Furthermore, the invention relates to a process for adhesively bonding molded articles made of hot melt adhesives and which enables a rapid and secure application onto various substrates.

### DETAILED DESCRIPTION OF THE INVENTION

A large number of known substrates can be used as the substrate. In particular these substrates are made of plastic or metal, but other substrates can also be used, such as e.g. wood, or wood materials, stone or concrete, glass or ceramics. The substrates are substantially rigid. However, thin, flat metallic or plastic substrates, such as e.g. sheet metal or plastic articles are particularly suitable molded parts. However they are usually not films.

The molded articles according to the invention can have any shape. One side should be shaped such that the molded articles can be used as a fastening device. One or more holding fixtures for example, can be provided on this side. Exemplary holding fixtures are screw threads, clips, brackets or even grommets. These holding fixtures are molded directly out of the material of the molded articles. They are used for directly holding in place the part to be clamped; however, they can also be used to attach a fastening device to the molded article. This is generally done after the adhesive bonding to the substrate.

The molded article comprises at least one flat surface that is designed for the adhesive bonding with the substrate surface. This must possess a base area that is sufficient to enable a secure adhesion of the molded article to the substrate. The bonding surface can have various shapes, in particular it is flat. However, in the case of textured substrates it can be matched to the shape of the substrate surface. An adhesion surface is preferably available. However, it is also possible to provide two adhesion surfaces in order to increase the adhesion surface or on structural grounds. These can be designed to match the substrate surfaces.

The molded articles according to the invention should consist of hot melt adhesives. They can be reactive or non-reactive hot melt adhesives. Such hot melt adhesives can be based for example on polyesters, polyurethanes, polyolefins, polyacrylates or polyamides.

Polyester-based hot melt adhesives are described in EP 028687 for example. These are reaction products of aliphatic, cycloaliphatic or aromatic dicarboxylic acids with aliphatic, cyclic or aromatic polyols. Crystalline or partially crystalline polyesters can be obtained according to the selected carboxylic acids and polyols. Usually dicarboxylic acids and diols are reacted with one another. However, it is also possible to add a fraction of tricarboxylic acids or triols.

Thermoplastic polyurethanes are described as hot melt adhesives in EP 434467 or DE 4128274. These are reaction products of polyols with polyisocyanates, which possibly have an increased modulus. Known polyols per se based on polyethers, polyesters, polyacrylates, polybutadienes, polyols based on vegetal raw materials, such as oleochemical polyols, can be employed as the polyols. Usually, at least a fraction of aromatic isocyanates is comprised in order to ensure a high reactivity. The properties of the prepolymers, for example the melting point, the flexibility or the adhesion, can be influenced by the choice of the polyols and/or isocyanates. However, reactive thermoplastic polyurethanes are also suitable which can crosslink after application, optionally also permanently.

Moreover, hot melt adhesives based on polymers are also known, such as for example polyolefins. They can be amorphous, crystalline or partially crystalline polyolefins. Examples of these are polypropylene or polyethylene copolymers. The properties of polymers of this type can be influenced by their molecular weight and by the copolymerized comonomers.

Such hot melt adhesives are described for example in WO 2004/039907, wherein in this case the polymers were manufactured by metallocene catalysis.

Additional suitable hot melt adhesives can be polyamides, for example. Exemplary suitable polyamides are described in EP 749463. They are polyamide hot melt adhesives based on dicarboxylic acids and polyether diamines. Particularly suitable hot melt adhesive compositions are described in EP 204 315. They concern polyester amides manufactured on the basis of polymer fatty acids and polyamines.

For example those based on dimer fatty acid-free polyamides can be selected as the inventively suitable polyamides. They can be manufactured from
40 to 50 mol %, preferably 50 mol %, of one or more C₄-C₁₈ dicarboxylic acid(s)
5 to 45 mol %, preferably 15 to 40 mol % of at least one aliphatic diamine
5 to 40 mol %, preferably 20 to 30 mol %, of one or more cycloaliphatic diamines
0 to 40 mol %, preferably 5 to 25 mol % of polyether diamines,
   wherein the sum of the added diamines is 50 mol %, such that dicarboxylic acid components and diamine components are present in approximately equivalent molar fractions.

However, the dicarboxylic acids are preferably added in up to 10% stoichiometric excess with respect to the diamines, such that carboxyl-terminated polyamides result. The molecular weight of the polyamides to be used according to the invention is about 10 000 to 50 000, preferably 15 000 to 30 000. The viscosity of these inventively suitable polyamides is between 5 000 and 60 000 mPas, preferably between 15 000 and 50 000 mPas (measured at 200° C., Brookfield Thermosel RVT, EN ISO 2555).

Exemplary dicarboxylic acids for manufacturing the inventive polyamides are especially adipic acid, azelaic acid, succinic acid, dodecanedioic acid, glutaric acid, suberic acid, maleic acid, pimelic acid, sebacic acid, undecanedioic acid or their mixtures.

The diamine component consists essentially of one or more aliphatic diamines, preferably with an even number of carbon atoms, wherein the amine groups are at the ends of the carbon chains. The aliphatic diamines can comprise 2 to 20 carbon atoms, wherein the aliphatic chain can be linear or slightly branched. Practical examples are ethylenediamine, diethylenetriamine, dipropylenetriamine, 1,4-diaminobutane, 1,3-pentanediamine, methylpentanediamine, hexamethylenediamine, trimethyl-hexamethylenediamine, 2-(2-aminomethoxy)ethanol, 2-methypentamethylenediamine, C₁₁-neopentanediamine, diaminodipropyfmethylamine, 1,12-diaminododecane. The particularly preferred aliphatic diamines are C₄-C₂ diamines with an even number of carbon atoms.

The amino components can also comprise cyclic diamines or heterocyclic diamines such as for example 1,4-cyclohexanediamine, 4,4′-diamino-dicyclohexylmethane, piperazine, cyclohexane-bis-(methylamine), isophoronediamine, dimethylpiperazine, dipiperidylpropane, norbornanediamine or m-xylylenediamine. If the polyamino amide should be more flexible, then in addition more polyoxyalkylenediamines can be incorporated, such as for example polyoxyethylenediamines, polyoxypropylenediamines or bis-(di-aminopropyl)-polytetrahydrofuran. The polyoxyalkylenediamines are particularly preferred in this respect. Their molecular weight is between 200 and 4 000 g/mol.

In addition, amino carboxylic acids or their cyclic derivatives can be incorporated. 6-Amino hexanoic acid, 11-amino undecanoic acid, laurolactam, ε-caprolactam may be mentioned here.

Another embodiment of the inventively suitable hot melt adhesives comprises a polyamide based on dimerized fatty acid as the essential component. Dimerized fatty acids are obtained by coupling unsaturated long chain monobasic fatty acids, e.g. linolenic acid or oleic acid. The acids are well known and commercially available.

The inventive polyamides are, for example, composed of
35 to 49.5 mol % dimerized fatty acid as well as
0.5 to 15 mol % monomeric fatty acid containing 12 to 22 carbon atoms and
2 to 35 mol % polyether diamines of the general Formula

H₂N—R⁵—O—(R⁶O)ₓ—R⁷—NH₂, (1)
in which
x stands for a number between 8 and 80, particularly between 8 and 40, R⁵ and R⁷ are the same or different aliphatic and/or cycloaliphatic hydrocarbon groups containing preferably 2 to 8 carbon atoms and R⁶ is an optionally branched aliphatic hydrocarbon group containing 1 to 6 carbon atoms, and
15 to 48 mol % aliphatic diamines containing 2 to 40 carbon atoms wherein up to 65 % of the dimerized fatty acids can be replaced by aliphatic dicarboxylic acids containing 4 to 12 carbon atoms.

Another suitable composition can be obtained from
20 to 49.5 mol % dimerized fatty acid as well as
0.5 to 15 mol % monomeric fatty acid containing 12 to 22 carbon atoms and
20 to 55 mol % of an amine containing 2 to 40 carbon atoms and carrying at least 2 primary amino groups,
   wherein up to 65% of the dimerized fatty acids can be replaced by aliphatic dicarboxylic acids containing 4 to 12 carbon atoms.

In regard to the amine components in the polyamides, preferably polyether polyols containing primary amino end groups are suitable, as already mentioned above. In this regard, polyether polyols containing amino end groups are preferred which are insoluble or only slightly soluble in water. The employed polyether polyols containing amino end groups have, in particular, molecular weights between 700 and 2500 g/mol. A particularly suitable class of raw materials are for example the bis-(3-aminopropyl)-polytetrahydrofurans.

Moreover, in particular, primary alkylenediamines containing 2 to 10 carbon atoms selected from the abovementioned amines can also be employed.

A further suitable class of diamines is derived from the dimer fatty acids and comprises primary amine groups instead of the carboxyl groups. These kinds of substances are often called dimer diamines. They are obtained by forming nitriles from the dimerized fatty acids and subsequent hydrogenation.

The abovementioned aliphatic dicarboxylic acids can be employed as the carboxylic acids. Suitable aliphatic carboxylic acids preferably have 4 to 12 carbon atoms. Up to 65 mol % of the dimer fatty acid can be replaced by these acids. Furthermore, long chain amino carboxylic acids such as 11-amino undecanoic acid or also lauryl lactam can be added.

In this regard, it is known to the person skilled in the art that the melting point of the polyamides can be increased within certain limits by adding sebacic acid. The polyamide raw materials known in fiber chemistry, such as for example caprolactam, can also be added in small amounts. These materials enable the person skilled in the art to increase the melting point within certain limits.

When choosing the monofunctional, difunctional or trifunctional raw materials to be added, one has to take into account that meltable, i.e. uncrosslinked products are to be obtained. For example, if crosslinking/gelling occurs, then lowering the fraction of trifunctional components (trimer fatty acids) and/or increasing the content of monofunctional amines or fatty acids can result in polymers that do not tend to gel.

In general, the quantities of the amine and the carboxylic acids are selected such that the polyamides contain 1-120 meq carboxyl groups per kg solids, particularly between 10 to 100 meq/kg. Alternatively, one can also work with an excess of amines; then an amine content between 1-140 meq/kg solids should be obtained, particularly between 10 to 100 meq/kg. The molecular weight (measured as the number average molecular weight, as obtained using GPC) can range between 30 000 to 300 000 g/mol, in particular between 50 000 and 150 000 g/mol. The viscosity of the polyamides should be between 5 000 and 100 000 mPas (measured at 200° C.), in particular up to 50 000 mPas.

In a preferred embodiment, 60 to 100 wt. % of polyamides are used as the hot melt adhesive. The other hot melt adhesive polymers can be the above-cited polyurethanes, polyacrylates or polyesters. They must also be compatible with the polyamide in the melt, i.e. form a stable homogeneous melt. In a particular embodiment, 35 to 15 wt. % of a poly(meth)acrylate polymer can be comprised. This can consist, for example of alkyl acrylate monomers; optionally other comonomers can be comprised, for example ethylene, propylene, styrene, or functionalized monomers. In particular, these poly(meth)acrylates should possess polar groups, for example OH, COOH groups or carboxylic acid anhydride groups.

Another embodiment employs only polyamides as the hot melt adhesive base polymer.

Furthermore, the inventively suitable hot melt adhesives can comprise additional usual additives. Examples of these are tackifying resins, such as e.g. abietic acid, abietic acid esters, terpene resins, terpene phenol resins or hydrocarbon resins; fillers, such as e.g. silicates, talc, calcium carbonate, clays, carbon black or pigments; antioxidants or stabilizers, e.g. of the sterically hindered phenolic type or the aromatic amine derivatives; fiber-forming additives, such as natural fibers, plastic fibers or glass fibers. Here, the antioxidants can be added in amounts of up to 1.5 wt. % based on the polymer. In general, an inventive hot melt adhesive can comprise not more than 10 wt. % in total of these additives.

Another inventively essential property of the suitable hot melt adhesives is that they must exhibit a high flexibility and a high strength. The strength can be characterized by the tensile stress at yield (measured according to EN ISO 527-1). It is inventively required that the tensile stress at yield (at room temperature) be between 1 and 35 MPa, in particular be from 3 to 20 MPa. The ultimate tensile strength should be between 1 and 50 MPa, especially between 10 up to 40 MPa. The elongation at break can be 200 to 1 000%. If the ultimate tensile strength is too low, then the mechanical (dimensional) stability of the molded article according to the invention is inadequate. For this reason it is possible that the molded article under mechanical loading by the part to be held can be deformed or breaks.

Another important property is that the hot melt adhesive of the molded article should have a softening temperature (measured according to ASTM E 28) above 100° C., especially above 150° C. The temperature can be up to 250° C., in particular up to 220° C. The choice of hot melt adhesives with a corresponding softening temperature is dependent on the substrates to be adhesively bonded. If the substrates to be adhesively bonded to the molded article are thermally less resistant, for example wood or plastic substrates, then it is also possible to employ a hot melt adhesive with a lower softening temperature than the molded article. When a high resistance of the substrate is required, then the hot melt adhesive preferably has a higher softening temperature. For this reason an improved thermal stability under load is required for the molded article bonded to the substrate, particularly for exposure to higher temperatures.

The molded articles according to the invention can be manufactured by known methods. For example, they are manufactured by injection molding processes. Accordingly, the hot melt adhesive can be injected into a suitable mold which, on the surface to be adhesively bonded, optionally has possible electrically conductive constituents that are bonded in this way with the molded article.

In another technique a two-shot process is used. Here, part of the mold is filled with an inventively suitable hot melt adhesive, the remaining part is filled with a mixture of hot melt adhesive and suitably conductive pigments or powders. In this way, particularly suitable molded articles can be manufactured, which can be inductively heated on the adhesion surface.

It is known to provide moldings with a non-stick coating for the manufacture of such molded articles. When required, it is also possible to provide the surface of the molded article with an agent to reduce adhesion. The manufacturing process can be simplified in this way.

It is inventively advantageous when the molded article additionally comprises electrically conductive constituents on or in the surfaces designed to be adhesively bonded with the substrate surface. These electrically conductive constituents are understood to include, for example perforated metal films, metal wires, metal powder, other conductive powdered materials, such as ferrite powder, cerium oxides or conductive carbon blacks. Such powders can consist of known metals, for example Fe, Co, Ni, Cu, Al, Zn, Sn or their alloys. Materials that can be inductively heated, especially metallic or ferrite particles in the form of powders, wires or meshes, are particularly suitable. In this case, such constituents should not be in the whole molded article, but only on the surfaces intended for the adhesive bonding. In one embodiment, these constituents have been incorporated into the surfaces intended for the adhesive bonding, i.e. these metallic conductive particles are completely encased by the hot melt adhesive. The thickness of the layer with such constituents should approximately correspond to the thickness of the adhesive layer to be melted. In another embodiment, such conductive constituents, such as perforated metallic films, metallic meshes or metallic wires, are deposited only on the surface of the surfaces used for adhesive bonding. In this case, the metallic articles are not completely encased by the hot melt adhesive. Those constituents embedded to a small extent in the hot melt adhesive should also be included in the definition that the molded article consists completely of the hot melt adhesive. These constituents do not contribute to the supporting structure of the molded article.

In another embodiment, the advantageous constituents for heating the molded article are located close to or beside the surface to be adhesively bonded. For example a wire, mesh or powder can be deposited on the periphery of a stud-shaped adhesion surface. A mesh, for example, can completely or also only partially cover the periphery. In this embodiment as well, the hot melt adhesive is heated on the adhesion surface and melted and can then be bonded. The distance of the inductively heatable article from the adhesion surface is chosen such that an adequate liquefaction of the hot melt adhesive on the point of adhesion is ensured.

Another subject matter of the invention is a process for adhesively bonding such hot melt adhesive molded articles on substrate surfaces. Industrial demands require short cycle times for adhesive bonding. The hot melt adhesive molded article is heated on the surface to be adhesively bonded, such that melting or softening occurs only at this point. The molded article is then pressed onto the substrate and is bonded fast on solidifying or recrystallizing.

An inventive technique is that the molded article is heated by a known method on the surface to be adhesively bonded with the substrate. This can occur for example by heating with hot gases, with infrared radiation or by contact with heated surfaces. It is essential to the invention that the molded article is heated only on the surface to be bonded. After heating, the molded article is immediately pressed onto the substrate. In this way the hot melt adhesive cools down and forms a solid bond with the molded article.

Another less preferred technique of the invention is that the substrate is at least punctually heated. The molded article is pressed onto the heated points. In this case, care should be taken that the heating on the points to be bonded is sufficiently high to melt the molded article at the surface to be bonded. This method is particularly suitable when the substrate can be heated to an adequate temperature without decomposition.

In a preferred embodiment, the molded article comprises metallic conductive powder or constituents on or beside the surface to be bonded. For bonding, these can be inductively heated, i.e. be subjected to electromagnetic fields. This leads to heating and melting of the hot melt adhesive. The molten adhesive on the surface to be bonded of the molded article is then pressed onto the substrate. In general, the inductive heating is then stopped such that the hot melt adhesive can cool down and then bond with the substrate. However, it is possible when required to also heat the hot melt adhesive of the molded article at the surface to be bonded for a short period after having pressed them together.

The hot melt adhesive should be heated strongly enough so that it can flow onto the substrate. This can optionally be supported by mechanical pressure, such as pressing. For example, the heating should be at least at 20° C., especially 30° C. above the melting point of the adhesive. A particularly rapid cooling and a rapid bonding is achieved when metallic substrates are adhesively bonded.

Devices for the direct heating of the molded article, for the inductive heating of the molded article and for bringing the molded article onto the substrate are known to the person skilled in the art. Suitable devices can be selected according to the required melting temperature of the molded article, the contact time of the bonding, shape of the substrate to be bonded.

If the melting point of the material of the inventively developed molded article is too low, then a temperature-stable adhesive bonding is not possible. In particular, if in addition mechanical loading occurs, for example vibrations, then a stable adhesive bond will not be achieved. The tensile stress at yield must preferably be greater than 3 MPa, otherwise the fastening device will not be provided with a sufficient holding force. If the value is too high, then the bond substrate/to the fastening object is too rigid, i.e. all the mechanical stress of the substrate will be passed on to the fastening object.

The process according to the invention is especially suitable with automated working processes for adhesively bonding molded articles as fastening devices onto flat surfaces which possess a shape that is designed within broad limits. In particular, the process according to the invention is for adhesively bonding suitable fastening clips or bolts onto metallic substrates, such as for example onto sheet metal substrates. Such bonded fastening clips can be used for example in the automotive industry, the aircraft industry, the general OEM industry or in the case of plastic or wood substrates in the furniture industry etc.

After bonding, the molded article is permanently bonded to the substrate surface. In the case of crosslinkable hot melt adhesives as the base material of the molded article, said adhesives can subsequently cure still further and establish an additional, normally chemically permanent bond.

Stable fixations are obtained when the molded article is totally made of hot melt adhesive. A failure of the adhesive joint is only possible on one surface, no further substrate/adhesive interfaces being produced. Moreover, the production of such molded articles is significantly easier than providing a coating of adhesive on metallic or plastic molded articles.

The invention is illustrated in more detail by means of the following examples:

### EXAMPLES

### Example 1

A polyamide was manufactured in a manner known per se by the condensation reaction of 50 mol % dodecanedioic acid, 25 mol % piperazine, 10 mol % Jeffamine D 400 and 15 mol % diaminohexane, and removal of the water of reaction. Key properties: Acid number: 15 mg KOH/g, Melt viscosity: 17200 mPa·s at 200° C., Softening point: 160° C., Ultimate tensile strength 15 MPa.

### Example 2

In the same way, a polyamide was manufactured from 50 mol % sebacic acid, 24 mol % piperazine, 16.5 mol % Jeffamine D 400 and 9.5 mol % ethylenediamine. Key properties: Acid number: 8.2 mg KOH/g, Melt viscosity: 17 000 mPa·s at 200° C., Softening point: 75° C., Ultimate tensile strength 25 MPa.

An object in the shape of a stud having a circular base surface of 1 cm was manufactured from the polyamides of examples 1 and 2. An iron powder or a copper mesh was incorporated into the surface of this base surface by heating.

The base surfaces of the molded articles were heated by induction and bonded to various flat substrates.

The base surfaces of the molded articles without added conductive additives were heated with a hot-air gun and adhesively bonded.

### Example 3

A molded article was manufactured from 75 wt. % of the polyamide of example 1 and 25 wt. % of an MA-grafted ethylene ethyl acrylate copolymer. A copper mesh with a width of 0.5 cm is applied round the adhesion surface on half the circumference of the stud. The molded article was adhesively bonded as in the example 1 and 2.

The samples adhered well to the substrate.

| | | |
|---|---|---|
| Metal substrate | up to 10 N/mm² | (shear strength, DIN 53283) |
| Plastic substrate | up to 10 N/mm² | |
| Wood substrate | up to 5 N/mm² | |

The adhesion is also still good when exposed to a temperature of 50° C. Plastic up to 100 N/cm (peel strength, DIN 53282)

### Comparative Test:

A polyamide plastic (PA 6) was melted and pressed onto a metal substrate. There resulted no adhesion.

Molecular weight>250 000 g/mol; yield stress ca. 50 MPa; elongation at break ca. 30%.

1. A molded article for bonding onto metallic or plastic substrates as a fixing device including a hot melt adhesive, wherein the hot melt adhesive is made of polymers based on polyamides, polyolefins, polyesters, polyacrylates or polystyrene, wherein the hot melt adhesive has a softening point between 100° C. and 250° C., a tensile stress at yield between 1 and 35 MPa and the molded article consists entirely of the hot melt adhesive.

2. The molded article according to claim 1, wherein the softening point is between 150° C. and 200° C. and the tensile stress at yield is between 3 and 20 MPa.

3. The molded article according to claim 1, wherein the hot melt adhesive is a polyamide, comprising 20 to 50 mol % dimer fatty acid and/or C₄ to C₁₈ dicarboxylic acids, 0 to 15 mol % monomeric fatty acid containing C₁₂ to C₂₂, 5 to 50 mol % aliphatic polyamines, 0 to 40 mol % cycloaliphatic diamines and 0 to 35 mol % polyether diamines and wherein the hot melt adhesive has a viscosity at 200° C. between 5000 and 100 000 mPas.

4. The molded article according to claim 3, wherein the polyamide comprises a total fatty acid amount of about 50 mol %, the total fatty acid amount being the dimer fatty acid as well as up to 65% of dicarboxylic acids, based on the dimer fatty acid, plus at least 0.5 mol % monomeric fatty acids, wherein the viscosity at 200° C. is greater than 15 000 up to 50 000 MPas.

5. The molded article according to claim 3, wherein the polyamide comprises at least 40 mol % C₄ to C₁₈ dicarboxylic acids but no fatty acid, and a mixture of aliphatic and cycloaliphatic diamines and optionally polyether diamines, wherein the amines are present in an amount of up to 50 mol %.

6. The molded article according to claim 1, additionally comprising 35 to 15 wt. % of a poly(meth)acrylate copolymer, wherein said acrylate copolymer possesses polar groups.

7. The molded article according to claim 1, wherein the molded article possesses at least one surface available for adhesively bonding to the substrate, wherein said surface possesses inductively heatable constituents.

8. The molded article according claim 1, wherein the molded article possesses at least one surface available for adhesively bonding to the substrate, wherein besides this surface constituents are present that can be inductively heated on the surface area of the molded article.

9. The molded article according to claim 7, wherein the inductively heatable constituents comprise a metallic grid, fleece, wire, perforated film or combination thereof.

10. The molded article according to claim 9, wherein the inductively heatable constituents are embedded in the hot melt adhesive or are located on the surface of the hot melt adhesive.

11. The molded article according to claim 7, wherein the inductively heatable constituents comprise powdered pigments embedded in said surface.

12. The molded article according to claim 11, wherein the inductively heatable constituents are present in a layer thickness in the hot melt adhesive which corresponds to a maximum of the thickness of the layer to be melted.

13. The molded article according to claim 12, wherein the layer thickness is less than 3 mm.

14. The molded article according to claim 1, wherein the molded article comprises a base surface for contacting and adhesive bonding to a substrate and at least one fastening part selected from clips, threads, holes, and brackets, said at least one fastening part being formed facing away from the base surface destined for adhesive bonding.

15. The molded article according to claim 14, wherein said substrate is selected from flexible substrates or rigid substrates.

16. A process for bonding molded articles onto metal or plastic substrates, wherein the molded article is made of a hot melt adhesive according to claim 1 and a surface facing the substrate is heated to a temperature of at least 20° C. above the softening point and is pressed onto the substrate simultaneously or immediately afterwards.

17. The process according to claim 16, wherein the surface to be adhesively bonded is heated by means of IR-radiation, microwave radiation, hot air, inductive heating or through the substrate.

18. The process according to claim 16, wherein the molded article on the surface to be adhesively bonded is heated by an inductively heatable, especially metallic grid, powder or wire.

19. The process according to claim 16, wherein the surface to be adhesively bonded is heated to a temperature of more than 30° C. above the softening point within 15 seconds.

20. A process of manufacturing adhesively bondable molded articles comprising:
combining 20 to 50 mol % dimer fatty acid and/or C₄ to C₁₈ dicarboxylic acids, 0 to 15 mol % monomeric fatty acid containing C₁₂ to C₂₂, 5 to 50 mol % aliphatic polyamines, 0 to 40 mol % cycloaliphatic diamines and 0 to 35 mol % polyether diamines to form a hot melt adhesive based on polyamides; amounts of said acids, polyamines and diamines being selected such that the hot melt adhesive has a softening temperature above 150° C. and a tensile stress at yield between 1 up to 35 Mpa; and
forming said hot melt adhesive into an adhesively bondable molded article.
